(19) United States
(12) Patent Application Publication
(10) Pub. No.: US 2007/0006290 A1
(43) Pub. Date: Jan. 4, 2007

(54) USB-compliant personal key

(75) Inventor: Jui Yu Li, Taoyuan (TW)

Correspondence Address: QUINTERO LAW OFFICE, 1617 BROADWAY, 3RD FLOOR, SANTA MONICA, CA, 90404, US

(73) Assignee: MITAC TECHNOLOGY CORP., HSIN-CHU HSIEN (TW)

(21) Appl. No.: 11/390,587

(22) Filed: Mar. 27, 2006

(30) Foreign Application Priority Data
Jun. 30, 2005 (TW) TW94122108

(51) Int. Cl. H04L 9/32

(52) U.S. Cl. 726/9

(57) ABSTRACT

A machine readable memory for enhancing security, a method for unlocking a computer, and a system for enhancing security. The system comprises a USB device having a descriptor and a computer. The computer comprises a machine readable medium storing a key and recording if a security function is activated; and a processor compares the descriptors with the key when the security function is activated, and the computer is unlocked when the key is a subset of the descriptor.

### BACKGROUND OF THE INVENTION

### Field of the Invention

The present invention relates to computer peripherals, and in particular, to a personal key providing computer security and personal identification capability.

In the last several decades, the use of personal computers in both home and office has become widespread. These computers provide a high level of functionality to many people at a moderate price, substantially surpassing the performance of large mainframe computers. The trend is further evidenced by the increasing popularity of portable computers, which provide high-performance computing power on a mobile basis.

While beneficial, the growing use of computers in personal communications, commerce, and business has also given rise to a number of unique challenges. The growing use of computers has resulted in the extensive unauthorized use and copying of personal data, violating the privacy of computer owners. Therefore, there is a need for systems and methods which prevent the unauthorized access of software and data.

One typical solution for protecting personal information in a computer uses a hardware security key as user identification, coupled to an input/output port of the host computer. A hardware security key such as a counter, a memory, a programmable or USB device, etc. or a combination of such devices contains or generates certain unique data which represents the identification of a user. If the proper hardware security has not been installed containing or generating the necessary secret data, some programs will not run on the computer, preventing the use of these programs to those who do not have the proper security key.

The use of the USB security key has certain inherent drawbacks depending on the type of protection system involved. The conventional USB security key can only manage access authority under some operating systems such as Windows. In other words, the program is only protected while the specific operation system is executed. If a hacker logs in via other operating system such as DOS, the security key does not protect the described programs. The hacker can access any file or data, and even destroy the contents via the DOS operating system. Moreover, a conventional security key requires the purchase of special devices or accessories.

### BRIEF SUMMARY OF THE INVENTION

A detailed description is given in the following embodiments with reference to the accompanying drawings. Accordingly, the invention provides a machine readable memory storing a security model used for enhancing security when an USB device is connected to a computer. The USB device has a descriptor, and the machine readable memory comprises a program which drives the computer to execute the steps comprising: searching all USB devices attached to the computer; listing at least one searched USB device(s); asking a user to choose one USB device as a security key; accessing the descriptor of the chosen USB device; forming a key according to the descriptor; storing the key into a nonvolatile memory in the computer, and setting a USB security flag to on.

The invention also provides a method for unlocking a computer on which a computer has key previously stored thereon. The method starts by detecting if any USB device having a descriptor is connected to the computer. The computer compares the descriptor of the USB device with the key stored in the computer. The computer is unlocked when the key previously stored in the computer is a subset of the descriptor.

The invention further provides a system for enhancing security. The system comprises a USB device having a descriptor and a computer. The computer comprises a machine readable medium storing a key, and recording if a security function is activated. The computer further comprises a processor comparing the descriptors with the key when the security function is activated. The computer is unlocked when the key is a subset of the descriptor.

### BRIEF DESCRIPTION OF THE DRAWINGS

The invention can be more fully understood by reading the subsequent detailed description and examples with references made to the accompanying drawings, wherein:

FIG. 1 shows a block diagram of an exemplary computer system;

FIG. 2 shows a flowchart of establishing computer security system; and

FIG. 3 shows a method for unlocking a computer on which a computer has key previously stored thereon.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

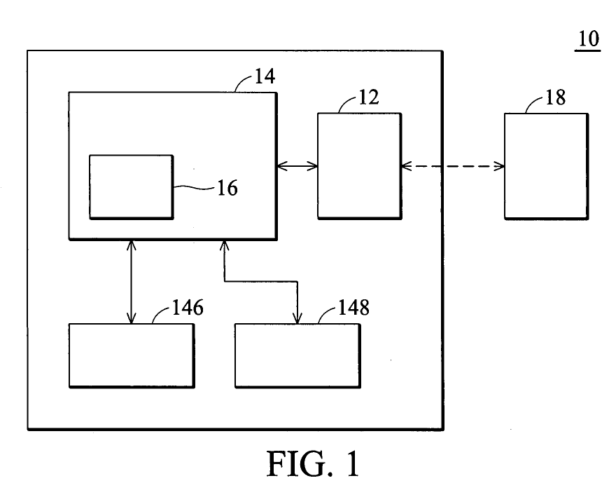

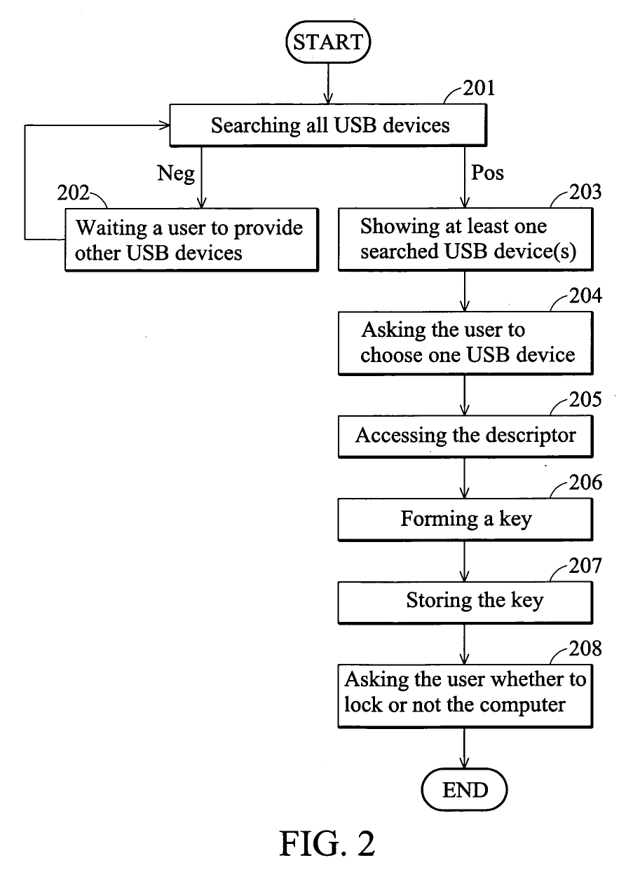

FIG. 1 shows a block diagram of an exemplary computer system, comprising a USB interface 12, a processor 14, user interface 146 and a basic input output system (BIOS) 148. The processor 14 loads a security model from user interface. The security model is software consisting of instructions. The processor 14 executes the security model to establish security when the computer connecting with an USB device. A flowchart of establishing computer security system is shown in FIG. 2. In step 201, the security model drives the computer to search all USB devices attached thereto. If the search result is negative, the computer waits for a user to provide other USB devices in step 202. If the search result is positive, the computer lists all attached USB devices in the user interface so that the user can choose a USB device as a security key. In step 203, the computer system lists at least one located USB device. In other embodiments of the invention, the computer lists all located USB devices in a user interface, allowing a user to choose a USB device as a security key. In step 204, the computer asks an end user to choose one USB device as a security key. Step 204 is optional, and in other embodiments of the invention the computer system can skip the step 204. In step 205, the computer accesses the descriptor of the chosen USB device. In step 206, the computer forms a key according to the descriptor. The key is formed according to the descriptor of the USB device. A descriptor of a USB device represents the entire device. As a result, a USB device can only have one device descriptor. The elements of the descriptor specify some basic, yet important information about the device such as vendor ID, product ID, device release number, manufacturer string, product string, and device serial number. The key may comprise some elements or all elements of the descriptor. The stored descriptor servers as a reference the next time the computer started. In step 207, the computer stores the key into a nonvolatile memory of the BIOS 148. The non-volatile device in BIOS 148 may be read-only memory (ROM), flash, erasable programmable read-only memory (EPROM) or electrical erasable programmable read-only memory (EEPROM), etc. In step 208, the computer asks the user whether locking the computer or not. If the user decides to lock the computer system, the computer sets a security flag to on. If the user decides not to lock the computer, the computer sets the security flag to off. The next time the computer system is started, a user must to plug-in the same USB device to complete the start-up process and successfully enter the operating system. The operating system herein may be Windows, Macintosh, DOS, Linux, Unix, and the like.

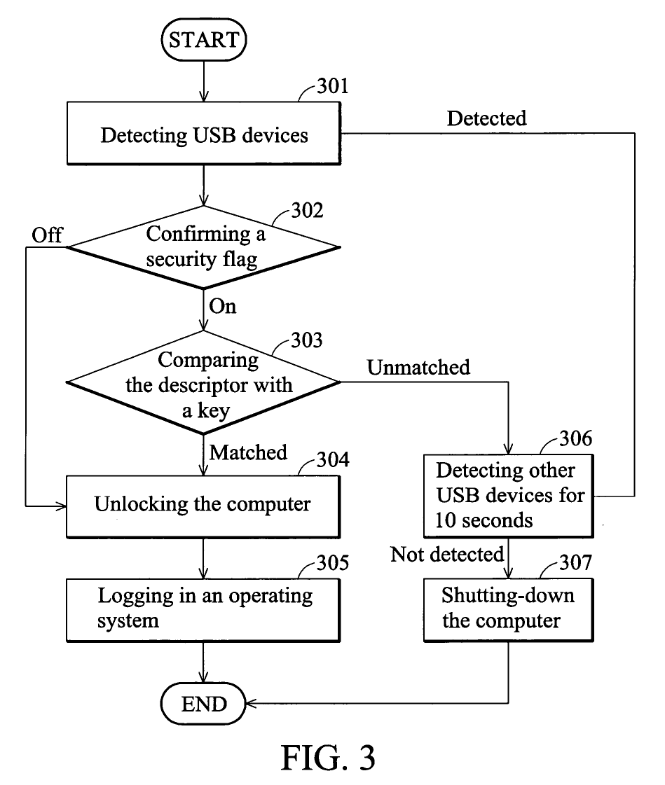

FIG. 3 shows a method for unlocking a computer on which a computer has key previously stored thereon. The method begins by detecting if any USB device having a descriptor is connected to the computer in step 301. In step 302, the computer confirms if a USB security flag is set to on. In step 303, if the USB security flag is set to on, the computer compares the descriptor of the USB device with the key stored in the computer. The computer is unlocked when the key previously stored in the computer is a subset of the-descriptor. If the USB security flag is set to off, in step 302, the computer is unlocked without checking if the key previously stored in the computer is a subset of the descriptor in step 304. In other embodiments of the invention, the computer is unlocked when the previously stored key is identical with the descriptor of the attached USB device. In another embodiment of the invention, the computer is unlocked only when the descriptor of the attached USB device is a subset of the previously stored key. The elements of the descriptor may be vendor ID, product ID, device release number, manufacturer string, product string, and device serial number. Following the step of unlocking the computer, a user is logged into an operating system in step 305. If the previously stored key is not a subset of the descriptor, the computer detects another USB device attached to the computer in step 306. In step 307, if the computer detects another USB device for a predetermined time period, the computer executes a shut-down process. In this embodiment of the invention, the predetermined time period is 10 seconds, while in other embodiments of the invention, the predetermined time is programmable.

FIG. 1 shows a system for enhancing security comprising a USB device 18 and a computer 10. The computer comprises a BIOS 148, a processor 14 and a user interface 12. The USB device 18 is a standard USB key that can be coupled to the USB port of USB interface 12. When coupled to the USB port of USB interface 12, process 14 can access and retrieve data stored on the descriptor of the USB key 18. The BISO 148 has a machine readable medium storing a key, and records whether a security function is activated. In this embodiment of the invention, logic high of a security flag means the security function is activated, while in other embodiments of the invention, logic low of the security flag means the security function is activated. The machine readable medium in BIOS 148 may include but is not limited to a nonvolatile machine readable medium so that contents stored therein remain after the computer is shut-down. The processor. 14 compares the descriptors with the key when the security function is activated, and unlocks the computer when the key is a subset of the descriptor. The descriptor comprises a vender ID, a product ID, a device release number, a manufacturer string, a product string, and a device serial number of the USB device. The user interface 12 displays all USB devices attached to the computer and the user can select one of the USB devices attached to the computer. The computer executes a start-up process when the descriptor in the USB device is identical with the descriptor stored in the computer.

According to an aspect of the present invention, a signature or key is stored in the non-volatile memory. Alternatively the key can be stored in the non-volatile memory of the host processor itself on another memory location within the computer system.

The invention provides a method to control access to an operating system when a USB is attached to an USB device. A user can use any USB device to lock his/her own personal computer without other hardware support. Once the security system is activated, a user must insert the correct USB device to start the computer. The mechanism can prevent unauthorized use of the computer system or hardware.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A machine readable memory storing a security model used for enhancing security when a USB device is connected to a computer, wherein the USB device has a descriptor, the machine readable memory further comprising a program which drives the computer to execute the steps comprising:
searching for all USB devices attached to the computer;
listing at least one located USB device(s);
asking a user to choose one USB device as a security key;
accessing the descriptor of the chosen USB device;
forming a key according to the descriptor;
storing the key in a nonvolatile memory in the computer; and
setting a USB security flag to on.

2. The machine readable memory as claimed in claim 1, wherein the descriptor has a plurality of elements, and the program further comprises forming the key by combining the elements.

3. The machine readable memory as claimed in claim 2, wherein the elements comprise a vender ID, a product ID, a device release number, a manufacturer string, a product string, and a device serial number of the USB device, and the step of forming the key by combining elements of the descriptor further comprises combining at least two elements as the key.

4. The machine readable memory as claimed in claim 3, wherein the key is formed by combining the vender ID, the product ID, the device release number, the manufacturer string, the product string, and the device serial number of the chosen USB device as the key.

5. The machine readable memory as claimed in claim 1, wherein the program further comprises asking the user whether to lock the computer, and setting the USB security flag to off when the user chose not to lock the computer, and setting the USB security flag to on when the user chose to lock the computer.

6. The machine readable memory as claimed in claim 1, wherein the program further comprises listing all searched USB device(s).

7. A method for unlocking a computer on which a computer has key previously stored thereon, comprising:
detecting if any USB device having a descriptor is connected to the computer;
comparing the descriptor of the USB device with the key stored in the computer; and
unlocking the computer when the key previously stored in the computer is a subset of the descriptor.

8. The method as claimed in claim 7, further comprising unlocking the computer when the descriptor of the USB device is identical with the key previously stored in the computer.

9. The method as claimed in claim 7, wherein the descriptor has a plurality of elements, further comprising unlocking the computer when the key previously stored in the computer is a subset of the a plurality of elements.

10. The method as claimed in claim 9, wherein the elements comprises a vender ID, a product ID, a device release number, a manufacturer string, a product string, and a device serial number of the USB device, further comprising unlocking the computer when the key previously stored in the computer is identical with the combination of the vender ID, the product ID, the device release number, the manufacturer string, the product string, and the device serial number of the USB device.

11. The method as claimed in claim 7, further comprising:
confirming if a USB security flag is set to on;
unlocking the computer when the USB security flag is set to on and the key previously stored in the computer is a subset of the descriptor; and
unlocking the computer without checking if the key previously stored in the computer is a subset of the descriptor when the USB security flag is set to off.

12. The method as claimed in claim 7 further comprising logging in into an operating system.

13. The method as claimed in claim 7 further comprising detecting other USB device(s) when the key previously stored in the computer is not a subset of the descriptor.

14. The method as claimed in claim 13, further comprising executing a shut-down process when the computer detects other USB device(s) for a predetermined time period.

15. The method as claimed in claim 14, wherein the predetermined time period is 10 seconds.

16. A system for enhancing security, comprising:
a USB device having, a descriptor; and
a computer, comprising:
a machine readable medium storing a key, and recording whether a security function is activated; and
a processor comparing the descriptors with the key when the security function is activated, and unlocking the computer when the key is a subset of the descriptor.

17. The system as claimed in claim 16, wherein the descriptor comprising a vender ID, a product ID, a device release number, a manufacturer string, a product string, and a device serial number of the USB device.

18. The system as claimed in claim 16, further comprising a user interface, wherein the user interface displays all USB devices attached to the computer, and the user can select one of the USB devices attached to the computer.

19. The system as claimed in claim 16, wherein the key is stored in a nonvolatile machine readable medium.
